(19) United States
(12) Patent Application Publication
(10) Pub. No.: US 2015/0097951 A1
(43) Pub. Date: Apr. 9, 2015

(54) Apparatus for Vision in Low Light Environments

(71) Applicant: Geoffrey Louis Barrows, Washington, DC (US)

(72) Inventor: Geoffrey Louis Barrows, Washington, DC (US)

(21) Appl. No.: 14/333,581

(22) Filed: Jul. 17, 2014

Related U.S. Application Data
(60) Provisional application No. 61/847,419, filed on Jul. 17, 2013.

(51) Int. Cl. H04N 5/243; H04N 7/18

(52) U.S. Cl. CPC H04N 5/243; H04N 7/183; Y10S 901/01
USPC 348/144; 901/1

(57) ABSTRACT

A vision system for use in dark environments is disclosed. The vision system comprises photoreceptor circuits for generating photoreceptor signals, pooling mechanisms for generating pool signals, and an image processing means. The structure of the vision system is inspired from that of nocturnal flying insects. Applications are disclosed including use of the vision system on a mobile platform such as an air vehicle to enable perception and flight stability in dark environments.

### CROSS-REFERENCE TO RELATED APPLICATIONS

This application claims the benefit of provisional patent application Ser. 61/847,419, filed Jul. 17, 2013 by the present inventor.

### FEDERALLY SPONSORED RESEARCH

This invention was made in part with Government support under Contract No. FA8651-13-M-0087 awarded by the United States Air Force. The Government has certain rights in this invention.

### TECHNICAL FIELD

The teachings presented herein relate to the processing of sequence of images in low light environments, and applications thereof to mobile robots and small unmanned air vehicles.

### BACKGROUND

There is a need for mobile platforms such as flying robots e.g. unmanned aerial vehicles (UAVs) to fly with autonomy in environments with limited amounts of light. This includes flight at night as well as indoors or deep inside caves, including when there is no lighting.

Techniques exist for implementing photodetectors that are extremely sensitive to light. This includes single photon avalanche diodes (SPADs), which are photodiodes strongly reverse biased so that the absorption of a photon results in an electron-hole pair that then causes an avalanche in the depletion region. Quenching circuits may then be used to reset the photodiode. This results in an easily detected current spike that may be used to generate a digital pulse or spike. Such circuits are in fact able to detect individual photons, however they also suffer from “dark current” in which spontaneously occurring electron hole pairs cause current spikes. One challenge in the design of such SPADs is to limit the dark current, so as to increase the “signal to noise ratio” of photon-induced spikes to spontaneously occurring spikes. Nevertheless, the art of SPADs is continuously improving, with some implementations having dark currents as low as 10 counts per second at the time of writing.

For this document, we shall refer to a “SPAD circuit” as a circuit, which may comprise a SPAD, its quenching circuit, and a digital output buffer that is capable of generating digitally readable pulses in response to absorbed photons. The implementation of SPADs is a known art in microelectronics, with many published papers detailing their construction. Two references, the contents of which are incorporated by reference, include the book “Fundamentals of CMOS Single-Photon Avalanche Diodes” by Matthew Fishburn, and the paper “Avalanche photodiodes and quenching circuits for single-photon detection” by S. Cova et. al. and published in Applied Optics in 1996.

It is well known that the arrival of photons at a SPAD (or other photoreceptor circuit) can be modeled as a Poisson process. The occurrence of spontaneous “dark current” electron hole pairs also arrives according to a Poisson process. It is also well-known that the standard deviation of a Poisson random variable grows with the square root of its mean. Thus the “signal to noise ratio”, defined by the standard deviation divided by the mean, grows with the mean. Thus the more photons accumulated, whether due to more light or integrating over a longer period of time, the less noisy the measurement of the intensity of light (e.g. photon rate) reaching the SPAD.

There are many studies in which insects have been shown able to fly in dark environments, such as at night. Such insects have photoreceptors that also respond to single photon events. Neural recordings in such insects show clear evidence of “photon bumps” or electrical pulses that result from individual photons being absorbed. Such insects have been shown able to fly in environments in which each ommatidia, or compound eye element, receives on the order of just several photons per second. The paper “Vision and Visual Navigation in Nocturnal Insects” by E. Warrant and M. Dacke, published in the Annual Review of Entomology in 2011 contains numerous examples. This paper is incorporated herein by reference.

It is believed that the reason many flying insects are able to operate in low light environments, in which each photoreceptor receives only several photons per second, is the existence of neural circuits that implement spatial and temporal pooling (also referred to respectively spatial and temporal summation). Essentially these neural circuits are believed to implement “pools” that effectively accumulate photon bumps from a region of photoreceptors, and thus implement a spatial smoothing. Furthermore, these pools are believed to integrate pulses over time. Thus the output of a single “pool” is effectively either a direct sum or a weighted sum of all photons acquired by a range of photoreceptors over an interval of time. The “one or two photons per second” from each ommatidia can turn into hundreds or more photons per second as perceived by the pool. Since the arrival of photons is effectively a Poisson process, the result is that the “signal to noise ratio” of the measured light intensity substantially grows. The reader is referred to the following papers, which are incorporated herein by reference: “A neural network to improve dim-light vision? Dendritic fields of first-order interneurons in the nocturnal bee Megalopta genalis” by B. Greiner et al, published in Cell Tissue Research in 2005; “Visual summation in night-flying sweat bees: A theoretical study” by J. C. Theobald et al, published in Vision Research in 2006; “Optimum spatiotemporal receptive fields for vision in dim light” by A. Klaus and E. Warrant, published in Journal of Vision in 2009; “Seeing in the dark: vision and visual behavior in nocturnal bees and wasps” by E. Warrant, published in the Journal of Experimental Biology in 2008; and “Wide-field motion tuning in nocturnal hawkmoths” by J. Theobald, E. Warrant, and D. O'Carroll, published in the Proceedings of the Royal Society B in 2009.

One well-known method for providing visual navigation to a UAV is through the use of optical flow. The computation of optical flow is a well-established art, as is its use in UAVs. The reader is referred to these documents, which are incorporated herein by reference: “Biologically inspired visual sensing and flight control” by Barrows, Chahl, and Srinivasan, in the Aeronautical Journal, Vol. 107, pp. 159-168, published in 2003; “An image interpolation technique for the computation of optical flow and egomotion” by Srinivasan in Biological Cybernetics Vol. 71, No. 5, pages 401-415, September 1994; “An iterative image registration technique with an application to stereo vision” by Lucas and Kanade, in the proceedings of the Image Understanding Workshop, pages 121-130, 1981; “A template theory to relate visual processing to digital circuitry” by Adrian Horridge and published in Vol. 239 of the Philosophical Transactions of the Royal Society of London B in 1990; U.S. patent application Ser. No. 11/905,852 entitled “Optical flow sensor” by Barrows; U.S. patent application Ser. No. 13/078,211 entitled “Vision based hover in place” by Barrows et al, filed 1 Apr. 2011; and “Vision based hover in place” by Barrows et al and published at the 50^{th} AIAA Aerospace Sciences Meeting in January 2012. For purposes of description, in the teachings below we will use the word “pose” to generally refer to the angular position of a UAV, as measured by traditional angles roll, pitch, and yaw, and we will use the term “position” to generally refer to the X,Y,Z Cartesian position of the UAV. Thus the pose and the position of an aircraft each describe three degrees of freedom in Cartesian space, and together describe six degrees of freedom in total.

It is well-known in the biology of flying insects that adequate visual perception for flight control may be obtained with resolutions of tens of thousands, thousands, or even just hundreds of photoreceptors distributed across the entire visual field. The pitch between photoreceptors in the eyes of flying insects is typically in the range of just several degrees. This results in resolutions that are several orders magnitude less than the megapixel resolutions typically found in almost all digital cameras at the time of writing. Visual flight control using resolutions of just hundreds of pixels, with pitches between pixels on the order of several degrees, has also been demonstrated by the present inventor at various times in the previous decade, for example as described in the aforementioned 2012 AIAA paper by Barrows and the 2003 paper by Barrows, Chahl, Srinivasan.

Further clues on the required resolutions of flying insects to perform various flight control behaviors may be obtained from cell recordings of wide field motion sensitive neurons observed in hawkmoths, as described in the aforementioned 2009 paper by Theobald, Warrant, and O'Carroll. Many such neurons show a peak response to spatial wavelengths on the order of 10 to 50 degrees per cycle. Since according to the Nyquist sampling theorem, the sampling rate should be at least twice the maximum frequency measured, and since neurophysiological studies suggest that the outputs of these neurons are sent to other neural circuits including those for flight control, these results suggest that spatial pooling implemented such that each pool responds to about a 5 to 25 degree region is adequate for some flight control behaviors, in particular when omnidirectional visual information is exploited. Furthermore many such neurons show a peak temporal response on the order of one Hz. This suggests that if flying insects are able to use mechanical means to control pose, then the residual optical flow due to self-motion may utilize a time constant or temporal integration period as little as a few tenths of a second.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts a vision system for sensing the environment using SPAD circuits and pooling mechanisms;

FIG. 1B depicts a circuit for providing high current pulses to an LED;

FIG. 1C depicts a structure for diffusing light from an LED;

FIG. 2 depicts a vision system for sensing the environment using shiftable receptive fields;

FIG. 3A depicts an active pixel sensor (APS) focal plane array;

FIG. 3B depicts an N-Well photodiode;

FIG. 4 depicts a vision system using active illumination;

FIG. 5A depicts an active pixel sensor (APS) circuit using just N-channel MOSFETS;

FIG. 5B depicts a multi-mode active pixel sensor (APS) circuit;

FIG. 6 depicts an exemplary multiple aperture camera; and

FIG. 7 depicts a coded aperture array camera.

### DESCRIPTIONS OF EXEMPLARY EMBODIMENTS

For purposes of discussion, let us define a few general terms that will be used in the teachings below. These terms are non-limiting and are used for illustrative purposes only.

A “raw photoreceptor”, “raw photodetector”, or “raw pixel circuit”, all terms equivalent, generally refers to a single circuit, which may comprise a photodiode, that generates a signal based on the light striking it. An image sensor will generally comprise an array of such raw photoreceptors. Such photoreceptor circuits may be constructed using active pixel sensors (described below), the aforementioned SPAD circuits, or by any other mechanism capable of responding to changes in light intensity.

A “pool”, “pooling circuit”, or “pooling mechanism”, all terms equivalent, generally refers to a circuit that performs spatial and/or temporal pooling to generate a single value from a region of one or more raw photoreceptors over a period of time which may include one or more sequential samplings of the raw photoceptors.

A “pixel” or a “pixel signal” generally refers to a single value making up one sampling point within an image.

A “raw pixel” generally refers to a pixel generated directly from a raw photoreceptor.

A “pool pixel” generally refers to a pixel generated by a pool.

It will be understood that both “raw pixels” and “pool pixels” are pixels. An image comprises a collection of pixels, often but not necessarily arranged in a two-dimensional array. Thus an image may be constructed from a collection of raw pixels or a collection of pool pixels. Either raw pixels or pool pixels may be used to form output imagery for other purposes, including for example vision-based control of a mobile platform such as an air vehicle.

A “receptive field” in the most general sense refers to the source of stimulus for a unit or device. For example, the receptive field of a pixel circuit or photoreceptor may refer to the area of a visual field to which it responds, due to the geometry of the optics between the pixel circuit and the environment. The receptive field of a pooling mechanism may refer to all pixel circuits or photoreceptors that provide input to it. The receptive field of a pooling mechanism may also refer to the angular region of the visual field to which those pixel circuits or photoreceptors collectively respond.

A “frame” generally refers to an image acquired at a single time instant or acquired in a manner consistent with a time interval. Two frames may correspond to two images acquired from the same set of raw pixels or pool pixels but at different times.

Pooling with SPADs: Basic Structure

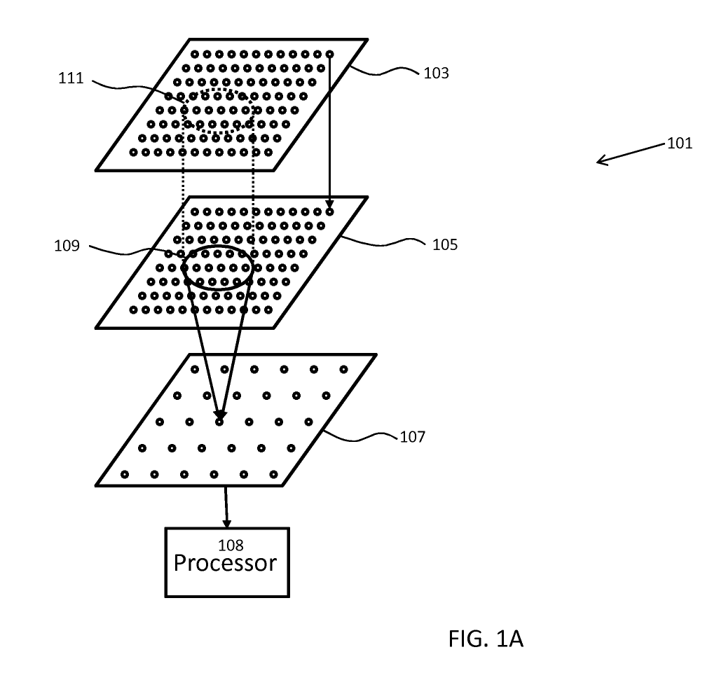

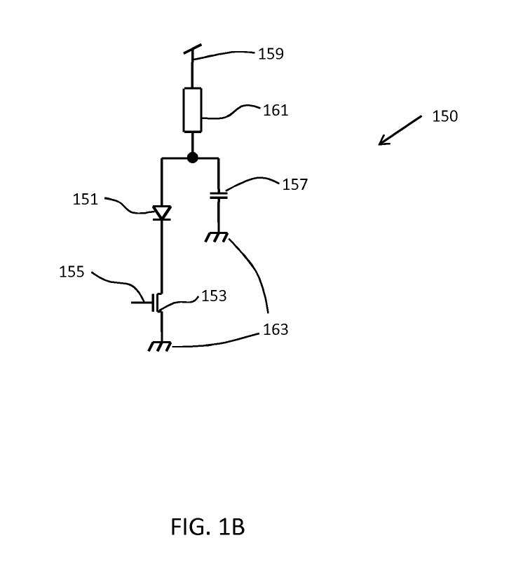

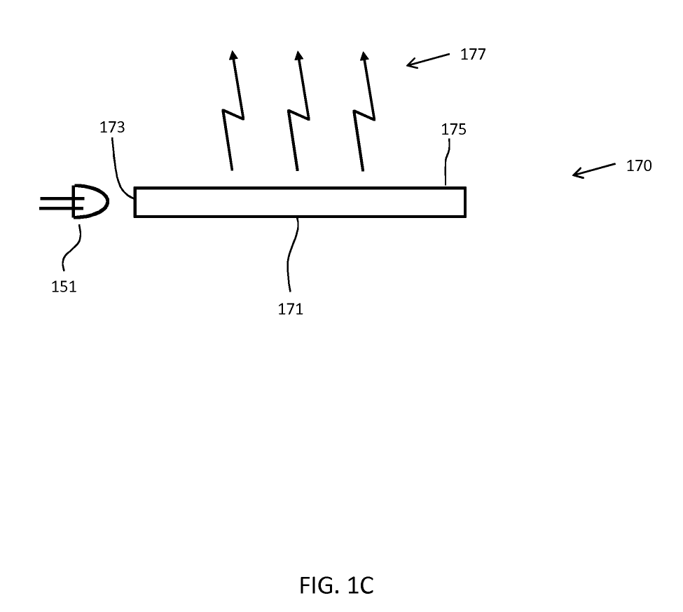

Refer to FIG. 1A, which depicts a vision system 101 for sensing the environment using SPAD circuits and pooling mechanisms. A lens or other optical apparatus (not shown) focuses light from the environment onto an array of SPADs 103, which are in turn located at a focal plane defined by the lens or optical apparatus. The array of SPADs 103 may be located on a monolithic integrated circuit. The construction of SPADs is a well-known art and may be performed in accordance with the above-mentioned references as well as other teachings in the known art. Each SPAD generates a substantially digital signal, which may be in the form of a digital pulse, that indicates the presence of an absorbed photon or a spontaneous electron-hole pair.

The SPAD array provides input to an array of pulse counting circuits 105. The counting circuit may be a simple flip-flop that sets (becomes digital 1) when the corresponding SPAD generates a pulse, or the counting circuit may be an actual counter that counts the number of pulses arriving. The pulse counting circuits may be configured to operate asynchronously in response to the SPAD array, with one pulse counting circuit responding to a corresponding SPAD circuit and counting the number of times the SPAD circuit generates a pulse or “fires”. The pulse counting circuit may be implemented using digital and/or analog circuitry, or even as a software algorithm.

The array of pulse counting circuits 105 provides input to an array of pooling mechanisms 107. Each pooling mechanism receives input from subset of the array of pulse counting circuits, which may be referred to as the receptive field of the pooling mechanism, for example receptive field 109. In turn, it can be said that the pooling mechanism receives input from a corresponding receptive field of SPADs, specifically those SPADs that provide input to the pooling mechanism's pulse counting circuits, for example receptive field 111. The term “receptive field” of a pooling mechanism may also be used to refer to the angular region in the visual field to which the pooling mechanism responds, as determined by the geometry of the SPAD circuits providing input to the pooling circuit, the optics of the vision system, and the position and pose of the vision system in the environment.

The shape of the receptive fields may be circular, for example as shown in FIG. 1A, or square or another shape. The receptive fields of different pooling mechanisms may be configured to overlap or to not overlap.

Each pooling mechanism computes an aggregate, for example an average or a sum, of all the pulses generated by all the SPADs that provide input to the pooling mechanism. The sum or average may use a uniform weighting, or it may be weighted, for example to implement a circular Gaussian smoothing kernel. This sum may be referred to as a “spatial sum” or as a “pool sum”. Additionally, the pooling mechanism may compute a time-domain average of the photons it receives. This may be performed by computing a sum of all photons received over a time interval, or this may be performed using a running average of the form:

R.Avg=R.Avg+alpha×(Current−R.Avg) (Eq. 1)

computed at regular intervals, where “R.Avg” is the running average, “Current” is the current number of counts over the current time interval or equivalently the “spatial sum” or “pool sum” of the pooling mechanism, and “alpha” is an update rate such as 0.1 for 10%. These two methods of implementing a time-domain average, or equivalently performing temporal pooling, are similar in that the output is based on the history of the photons received over multiple time intervals.

The array of pooling mechanisms generates one or more output images. Each image may be a downsampled version of the raw photon “image” acquired by the SPAD array. For example, if the SPAD array is sized 100×100, the array of pooling mechanisms may compute an effective 20×20 array of pooling pixel signals. This can be performed by, for example, having the first (or top-left) pooling mechanism receive input from the first (or top left) 10×10 block of SPADs, the second pooling mechanism receive input from a 10×10 block of SPADs shifted five over to the right, and so forth. In this case, the receptive fields would be overlapping. Alternatively, each pooling mechanism may receive input from just a 5×5 block of SPADs, in which case the receptive fields of the pooling mechanisms may be nonoverlapping. Clearly the array of pooling mechanisms can output multiple images, for example one sized 20×20, another 50×50 and another 5×5, and so on. Pooling mechanisms that generate lower resolution output images may have larger receptive fields than the pooling mechanisms that generate higher resolution output images.

Spatial pooling may be described in a more rigorous form, as described in an exemplary, non-limiting manner below: Suppose the SPAD array is sized 100×100 and arranged in a 100×100 square grid, and there is one pulse counting circuit for each SPAD circuit. It will be understood that other array sizes may be used, and the array may be arranged according to other geometries, for example in a hexagonal geometry. Suppose C_{i,j} denotes the number of pulses counted by the counting circuit associated with the SPAD circuit at row i and column j. The top left counting circuit may be denoted with i=0 and j=0. Suppose the pooling mechanisms are arranged in a 20×20 grid, with P_{i,j} referring to the pooling mechanism at pool row i and pool column j. The pooling mechanism may, for example, be configured to receive input from a 10×10 block of pulse counting circuits, with an overlap of 5 pixels. In this case, pooling circuit P_{i,j} receives as input the values C_{k,l} where k ranges from i×5 to i×5+9 and 1 ranges from j×5 to j×5+9, and may compute a sum of these 100 C_{k,l} values.

Finally, these images generated by the pooling mechanisms may then be processed by any vision algorithm desired. This may be, for example, an optical flow algorithm or a feature tracking algorithm. One possible optical flow algorithm is algorithm “ii2”, depicted in MATLAB in the aforementioned U.S. patent application Ser. No. 13/078,211 by Barrows et al. This algorithm ii2 would be provided as an input two images provided by the array of pooling mechanisms, which would be the outputs of the same set of pooling mechanisms at two different times. Another algorithm is the Horridge Template algorithm, as described in the aforementioned publication by Adrian Horridge and further described in U.S. patent application Ser. No. 11/905,852 by Barrows.

It is also possible, as suggested above, for the pooling circuits themselves to implement temporal summation in addition to spatial summation. This may achieved, for example, by adding a running average or similar time-averaging mechanism to the pooling mechanisms which takes as input the spatial sum value and generates a spatial and temporally pooled value (also known as a “spatio-temporal pooled value”).

We may introduce several terms to help explain the configuration of the pooling mechanisms as described above. The terms “spatial pooling configuration” or “spatial pooling amount” generally refers to the shape and size of the receptive fields of a pooling mechanism. In the above example where each spooling mechanism receives input from a 10×10 array of SPADs, the spatial pooling configuration would be a “10×10 square” and the spatial pooling amount would be “10×10” or “100 inputs” or “a width of 10”.

Similarly, the terms “temporal pooling configuration” and “temporal pooling amount” generally refers to the manner in which photon-induced pulses are integrated over time. The temporal pooling configuration may be, for example, a running average with a 0.1 update rate as described above, or may be a simple sum over a time window of 10 frames, e.g. the “history” over the past 10 frames. In these cases, the temporal pooling amount may be described as “10 frames”.

The terms “pooling configuration” and “pooling amount” generally refer to combinations of spatial and temporal pooling, including whether each is used. The terms “spatio-temporal pooling configuration” and “spatial-temporal configuration” may equivalently be used.

It will be understood by the reader that the above terms are general non-limiting terms used for descriptive purposes, and that the specific interpretations thereof are particular to the specific implementation or embodiment.

Pooling and Noise

The benefits of pooling may be mathematically described as increasing the signal to noise ratio of the “pixels” that make up an image. It is well known that photons arrive as a Poisson process. If, over a time interval, a pixel circuit or photoreceptor receives λ, photons on average (the average depending on ambient illumination and the reflectance or albedo of the object being imaged), the probability mass function describing the chance that k photons will be detected is according to the classic Poisson distribution:

$$P ( λ = k ) = \frac{{λ}^{k} {e}^{- λ}}{k !} . \qquad ( Eq . 2 )$$

The mean “mu” of P is λ and the standard deviation “sigma” of P is the square root √λ. Thus the signal to noise ratio SNR is mu divided by sigma, or √λ. It is beneficial for the SNR to be as large as possible, or for “mu” to be much greater than “sigma”.

The purpose of temporal pooling is to essentially increase the time period over which photons are accumulated. If the duration of the integration is increased by a factor A, then “mu” increases by A and “sigma” increases by √A, therefore the signal to noise ratio increases by √A.

Similarly, the purpose of spatial pooling is to increase the number of photons accumulated by gathering photons over a larger area of the image. In spatial pooling, the SNR of individual resulting “pixels”, formed from the aggregate of pools, is increased at the expense of lowering spatial resolution. If spatial pooling is applied so that one pool aggregates the information from B individual raw pixels, then in the same manner as temporal pooling, “mu” increases by B while “sigma” increases by √B.

Spatial and temporal pooling may be combined to further increase the signal to noise ratio, which may result in “mu>sigma” for even extremely dark environments. Of course, there is a trade-off: Too much temporal pooling can slow down the effective response of an imaging system to be impractical, while too much spatial pooling can reduce the spatial resolution of images beyond what is useful. As discussed in the aforementioned 2009 paper by Klaus and Warrant, there may be “optimal” spatial and temporal pooling amounts, depending on the task at hand and depending on the ambient light levels in the environment.

The presence of dark current may also be a source of noise. Suppose the dark current rate is λ_{d}. Since dark current also arrives as a Poisson process, it manifests itself as an independent noise of strength √(λ_{d}). The total noise that would need to be overridden will now be “sigma”=√(λ+λ_{d}).

It will be understood by the reader that in the teachings that follow, we will use the term “mu” to refer generally to the strength of a pixel signal to be received, in particular an intensity of light perceived at a pixel or a pool due to the intensity of an object being imaged at the receptive field of the pixel or pool. The value “mu” is essentially the “ideal” value received if noise were absent. We will similarly use the term “sigma” to refer generally to the noise of the same pixel signal, whether due to the standard deviation of a Poisson random variable or due to any other source of noise. We will refer to the condition of “mu>sigma” occurring when the strength of a signal is adequately strong that it may be distinguished from the noise that corrupts it. These are non-limiting terms used for illustrative purposes. The amount by which “mu” needs to exceed “sigma” may depend on the specific algorithm—a factor of one or a factor of ten or another amount may be appropriate. Thus one could refer to the “mu>sigma” condition as occurring when, mathematically, mu>k×sigma where k is a scaling threshold factor.

Let us consider the effects of pooling. Consider the same 100×100 array described above, and let λ=0.1 photons per frame (or other useful time unit) for each pixel circuit. The SNR at one photoreceptor would be less than one, or qualitatively useless by itself. Now consider the effects of temporal pooling at a counting circuit: If temporal pooling is implemented so that the counting circuits sum over 10 frames or utilize a running average with an update rate of 0.1, the sum detected by the counting circuit will be a random variable with a mean of 10×0.1=1. In this case since √1=1 the signal “mu” would be as strong as the noise “sigma”. Suppose then spatial pooling were provided, so that each pooling mechanism receives input from 100 counting circuits over a 10×10 grid. The “mu” value of the pooling circuit would be 100, while the “sigma” value would be 10 since √100=10. The signal would be substantially stronger than the noise, with an SNR of 10, resulting in a useful pixel signal. Suppose this process were repeated across the entire 100×100 array. Even though the individual photoreceptor or SPAD circuits present substantially useless information, the resulting 20×20 array of pool signals would have an adequately high signal to noise ratio to be useful.

For purposes of discussion, it will be understood that terms such as “photon rate” and “mu>sigma” may be applied to the pixel signals generated by pooling circuit as well as to the raw pixel signals. Suppose raw pixel signals have an average photon rate of one pixel per frame, with one frame lasting 10 milliseconds. Suppose spatial pooling were implemented using 10×10 receptive fields, and that temporal pooling was implemented by summing photons received over the past 100 milliseconds. The photon rate at the pool mechanism would be about 1000 times that at the raw pixels, or 1000 photons per second. These rates may then be associated with a corresponding SNR and “mu>sigma” condition at the pool mechanism.

Implementation

The above structure outlined in FIG. 1A may be implemented in many different ways. For example, each of the pulse counting circuits 105 may be a flip flop that stores only whether a SPAD has generated a pulse within a time interval. This “flip flop” may be an actual sequential logic flip flop constructed with several gates, or it may be a dynamic flip flop implemented by a capacitor with the presence of charge or the lack of charge to indicate logic values. In the latter case, techniques used for implementing semiconductor dynamic RAM (random access memory), which is a known and mature art, may be utilized to implement extremely small circuits. Each pulse counting circuit may then be connected to its corresponding SPAD circuit so that when the SPAD generates a pulse, the flip flop in the pulse counting circuit is set to a digital 1. At the beginning of a time interval, the pulse counting circuits may be reset to a digital 0. Thus the value of each pulse counting circuit at the end of the time interval indicates whether its corresponding SPAD circuit has generated a pulse or fired during the time interval. The pooling mechanisms may be implemented in software or algorithmically by a processor 108 programmed to query the pulse counting circuits and mathematically compute the pooling mechanism output values. Each cycle, the processor 108 would complete the following steps:

Algorithm 1:

Step 1: Check the pulse counting circuits 105 to determine if a pulse has been received, thus receiving a binary 1 or 0 for each SPAD.

Step 2: For each pooling mechanism of 107, count how many SPADs in its receptive field have generated a pulse by observing the 1 or 0 value in the pulse counting circuit flip flops. This implements spatial smoothing or spatial summing.

Step 3: For each pooling mechanism, compute an aggregate or count of how many total photons have been received by the receptive field of SPADs over a “longer time interval” or based on the history of the SPADs. This may be performed by simple addition, or by a running average using the formula listed above. This implements temporal summation.

Step 4: Generate one or more output images based on the pooling mechanism values, and then perform any other image processing algorithms using the output images. This may include, for example, algorithms to measure optical flow.

Step 5: Reset the pulse counting circuit flip flops

Step 6: Delay, and go to Step 1.

In order to ensure that all photon events are captured, the above six steps may need to be performed at a high rate, for example 10,000 cycles per second or every 100 microseconds. Every such cycle, the counting circuit flip flops would be queried for their 1/0 value and then reset. To implement temporal pooling, for example, over a 100 msec timeframe, the pooling mechanisms could sum the photon counts over 1000 cycles, e.g. over the history of the past 1000 cycles, or it could use a running average with an update rate of 1/1000.

Using indexing schemes, the above six steps should have modest CPU requirements. For example, when one SPAD circuit pulses, it may flash a code word on an output bus, in a manner similar to that described by so-called “address event representation”. This codeword may then be detected and decoded by the processor or by other digital logic. Techniques for implementing address event representation are described in the paper “Point-to-point connectivity between neuromorphic chips using address events” by K. Boahen and published in IEEE Transactions on Circuits and Systems—II: Analog and Digital Signal Processing in 2000, the contents of which are incorporated herein by reference.

Variations of the above are possible. For example, the pulse counting circuits could actually be digital counters that count to a value greater than “1”. The pooling mechanisms may then receive as input and accumulate integer or analog values from the counting circuits rather than just binary values. This would increase the complexity of the pulse counting circuits, but would allow the above six steps to be performed at a lower rate. Another variation is to eliminate the pulse counting circuits, and have the SPAD circuits send digital pulses directly to the pooling mechanisms, so that the pooling mechanisms may themselves perform counting in either an analog or digital fashion.

Regarding the computation of optical flow from photon-limited images: In previous studies, we have found that various optical flow algorithms, such as the aforementioned “ii2” algorithm and the classic “block matching” class of algorithms, as well as the aforementioned Horridge Template algorithm, may be configured to produce useful results with surprisingly few photons. When contrast levels are high, so that the brightest parts of an image are many times as bright as the darkest parts of an image, optical flow measurements may be obtained with as few as 100 photons per frame over the entire image. When the contrast levels are lower, generally more photons are beneficial—1000 or even 10,000 or more photons per frame may be optimal. A “frame” in this case may be the outputs of an array of pools as generated in Step 4 of algorithm #1 above. Thus two sequential “frames” would be two images output by the above pools at two time instances. Each frame may be constructed from many cycles of the algorithm above, with each cycle contributing to the frame using temporal summation.

Adding Active Illumination

In some cases there may be so little light that the dark noise current of the SPADs dominates. In this case, it will be useful to use active illumination, such as that formed by light emitting diodes (LEDs) attached to the UAV. The LED would then illuminate the environment so that it may be observed. It is possible to reduce the effects of dark current noise by using the following algorithm:

Algorithm 2:

Step 1: Reset the pulse counting circuits

Step 2: Turn on the LED for a very short period, such as a millisecond or a microsecond or another appropriate time interval. Allow the pulse counting circuits to count pulses during this time interval.

Step 3: Turn off the LED.

Step 4: For each pooling mechanism, query how many photons have been received by the SPADs in the pooling mechanism's receptive field during the period in which the LED was on, and then implement spatial summation and/or temporal summation using any of the techniques described above.

Step 5: Generate one or more output images based on the pooling mechanism values. Perform any other desired image processing algorithms on these output images. This may include, for example, algorithms to measure optical flow.

Step 6: Delay a small amount, then go to Step 1.

In this variation, the delay in Step 6 may be long enough so that the LED is on for a limited duty cycle, for example 1% or 10% or another fraction. For example, if the LED is on for only a microsecond, but the delay in Step 6 is such that all six steps require 1 millisecond, then the duty cycle would be 0.1%.

It is also beneficial for the LED to be adequately bright that the condition of “mu>sigma” is achieved in the generated pixel signals. The condition of “mu>sigma” may be measured at the raw pixel level, or may be measured at the pool level, the latter of which may require a less bright LED. The value of “mu” would thus be the number of photon-induced pulses and may have a mean of λ, with this value analyzable using radiometric principles using the LED's brightness and beam pattern, the distance to and albedo of any texture being illuminated, the geometry of the optics used in the vision system 101, and the geometry of the pixels 103 based at the focal plane. The value “sigma” may then depend on both the standard deviation of the number of photon-induced pulses, e.g. √λ, and either the expected dark current λ_{d} or it's standard deviation √λ_{d}. Generally the brighter the LED, the larger the value λ. If the condition “mu>sigma” is measured at the pool mechanisms, then the spatial and temporal pooling amounts would also factor into the calculation of “mu” and “sigma”. It will be understood, therefore, that the values “mu” and “sigma” may likely be different at the photoreceptor level or the pulse counting circuit level than they are at the pooling mechanism level, and that “mu>sigma” may be achievable at the pooling mechanism level even if it is not achievable at the earlier levels.

This technique has three advantages. First, the LEDs will provide illumination into the environment so that vision is possible even in “100% dark” environments. Second, because photons are integrated only over the short time interval from Step 1 through Step 3, less dark current pulses will occur than if measured over the entire duration of the cycle through Step 6. This may substantially increase the signal to noise ratio. For example, if the LED duty cycle is 0.1%, and the individual SPADs have a dark noise of 100 counts per second, then their effective dark count rate will be just 0.1 dark noise counts per second after the above set of steps is performed. The third advantage of this technique is that the pulsing of the LED may be synchronized with some mechanical aspect of the platform on which the vision system is mounted, for example oscillating motions or jitter due to the turning of a propeller or the flapping of a wing if the system is mounted on a UAV, that can minimize the effect of these oscillating motions. The LED may emit in the visible light spectrum, or it may emit in the near infrared spectrum so as to be invisible to humans for stealth purposes.

For implementing temporal pooling, it is possible in Step 4 to generate the output images based on more than one cycle of the above algorithm. In other words, the output would be based upon the spatial pooling sums, added up to accumulate the effects of photons acquired over multiple pulsings of the LED. In other words, the output of each pooling mechanism may be based on the history of the spatial sums computed by the pooling mechanisms. When combined with synchronizing the LED pulsings with the UAV mechanical jitter, this method may allow the “mu>sigma” condition to be made even in the presence of severe mechanical jitter and low light levels.

When active illumination is combined with temporal and spatial pooling, an added advantage is that a dimmer LED may be used to adequately illuminate the environment to achieve “mu>sigma” than what may be required without such pooling. In fact, it may be possible to select the LED brightness so that “mu>sigma” when measured at the pooling mechanisms but not at the individual raw pixels.

Variations of the above algorithm are possible. For example, Step 2 may be modified so that the on-duration of the LED varies with knowledge of the environment. For example, if the vision system is operating in a smaller environment, then the LED need not be on as long to achieve the same level of illumination. It may also be desirable to automatically leave the LED off if the ambient light levels are sufficiently high.

The LED may be pulsed simply by connecting it to the output of a microcontroller or processor. Depending on the rating of the LED it may be beneficial to include a resistor in series with the LED to limit current. If the desired LED current is higher than the rating of the microcontroller or processor, then it may be beneficial to drive the LED using a transistor.

In some implementations, however, the amount of current to be driven through the LED may be higher than the capability of its power source to provide, or the large current spike may have adverse effect on other circuits connected to the same power source. In this case, it may be beneficial to use a separate capacitor to power the LED. This may be performed with the circuit of FIG. 1B, which depicts a circuit 150 for providing high current pulses to an LED 151. Transistor 153 may be an N-channel MOSFET (metal oxide semiconductor field effect transistor) or another suitable transistor or electronic switch. Its gate input 155 is connected to a pulse source (not shown), such as that may be provided at the output of a processor. It may be beneficial to connect gate input 155 to the pulse source with a resistor (not shown) rather than a direct wire, especially if a bipolar junction transistor (BJT) is used for transistor 153. Another resistor (not shown) connected between the gate input 155 and ground 163 may serve to keep transistor 153 turned off in the event it's input is left floating. The cathode of LED 151 is connected to the transistor 153, while the anode of LED 151 is connected to a capacitor 157. The capacitor 157 is charged from a power source 159 via a resistor 161. The capacitor 157 is chosen to provide a desired amount of total charge to the LED 151. It may be beneficial for the capacitor 157 to have a low series resistance, for example as found in ceramic capacitors. It may be beneficial to insert a low-valued resistor (not shown) in series between the LED 151 and the transistor 153 to limit current. Alternatively the low-valued resistor (not shown) may be placed between the transistor 153 and ground 163, in which case the voltage drop across it may be used to measure current flow. The resistor 161 may be chosen so that it provides enough current to charge the capacitor 157 in between pulses, but low enough so that the current draw of the circuit 150 is within the limits of the power source 159 and will not adversely affect other circuits connected to it. When input 155 is pulsed high, transistor 153 turns on, and LED 151 is powered by capacitor 157 for a short duration until either the capacitor 157 discharges or the input 155 turns off. An advantage of circuit 150 is that when the duty cycle of the input signal 155 is small, it may be possible to overdrive the LED 151, e.g. provide it with a much higher current than for which it is rated. This may allow a desired amount of intensity to be provided with fewer LEDs, resulting in a lighter and less expensive circuit. In our experiments, we have overdriven LEDs by a factor of 20 without damaging the LED, thus allowing one LED to provide, for short periods, the brightness of 20 of the same type of LED. It will be understood that variations of circuit 150 are possible, for example powering multiple LEDs in series or in parallel, using one or more transistors, depending on the particular needs of the implementation.

Another variation is to add a diffusing mechanism to the LED to assist with the dispersion of light. Refer to FIG. 1C, which depicts a structure 170 for diffusing light from LED 151. The structure comprises an optical sheet or bar 171, which may be constructed from an optically transparent material, such as glass or acrylic, that has a higher index of refraction than the surrounding environment. The sheet may be polished to a flat finish, except for the top side 175 which might be slightly sanded down or otherwise given a rough finish. The LED illuminates the sheet 171 from the side 173, so that light enters the sheet 171. This light will generally stay inside the sheet due to Snell's Law, in much the same manner that light stays inside a fiber optic cable. However some of the light will exit the top side 175 in a diffused fashion 177 into the environment. The benefit of this approach is that the light from the LED 151 will still be dispersed into the environment, but not from a single point source. This may improve the stealthiness of the emitted light, especially if sheet 171 is wrapped around the body of a mobile robot or UAV. This method may also allow a single LED to provide illumination over a very wide field of view. Alternatively, the LED 151 may be placed inside a translucent shell.

It will be understood that although the above example uses an LED for illumination, any other device capable of illuminating the environment at the desired level and wavelength may be used.

Adaptive Spatial and Temporal Summing

The aforementioned paper “Visual summation in night-flying sweat bees: A theoretical study” by J.C. Theobald et al discusses the merits of altering the spatial and temporal summation of photon events according to the environment and the illumination levels. This can certainly be implemented in the system of FIG. 1A, by adding a step to modify the shape of the receptive field for each pooling mechanism and/or by modifying the time interval (or running average update rate) over which photons are accumulated.

For example, in Algorithm 1 above, a “Step 1B” may be added between Steps 1 and 2 to compute new spatial and/or pooling parameters based on the global illumination levels or based on the current application. Step 2 would then be modified to use the selected temporal smoothing amount, and Step 3 would be modified to use a new receptive field based on the selected spatial pooling amount as well as any additional temporal pooling implemented in Step 3. Similar changes may be made to Algorithm 2 above, or to other algorithms described further below.

In general, it is beneficial to make the receptive fields smaller, and use more of them, when the light levels are higher, and likewise make the receptive fields larger, and use fewer of them, when light levels decrease. The resulting resolution of the image generated by the pooling circuits would thus decrease with lower light levels. Similarly it is beneficial to increase temporal pooling as light levels decrease. Essentially the goal is to increase the amount of spatial and/or temporal pooling so that the aforementioned condition “mu>sigma” is obtained for the resulting pixels.

The extent of spatial pooling or temporal pooling or a selected amount of each is applied may also depend on the application. If the camera system is used in an environment that is still or slow-moving, then it may be reasonable to first attempt to obtain “mu>sigma” by just increasing temporal pooling. This would preserve spatial resolution as much as feasible. Then when the resulting frame rate approaches the lower limit of practicality for the situation, spatial pooling may be applied. If the camera system is used in an environment that is rapidly moving or changing, then it may be beneficial to apply spatial pooling first.

The above-described Step 1B may be implemented as follows:

Step 1B.1: Determine whether “mu>sigma” is achievable at raw resolution, e.g. no spatial pooling, and at full frame rate, e.g. with no temporal pooling. If yes, then select to use no spatial or temporal pooling. Step 1B is now complete. Otherwise, proceed to Step 1B.2 below, starting evaluation with no spatial or temporal pooling.

Step 1B.2: Increase temporal pooling as much as possible, within the practical limits of the application. If “mu>sigma” is reached while temporal pooling is still practical, then select this value for temporal pooling, and select the currently evaluated spatial pooling amount for spatial pooling. Step 1B is now complete. If “mu>sigma” is not reached, go to Step 1B.3. For example, if using optical flow, then increase temporal pooling until either “mu>sigma” is reached, which indicates success, or until the maximum optical flow would exceed one pixel per frame, which indicates failure and progression to Step 1B.3.

Step 1B.3: Increase the spatial pooling amount being evaluated to the next level. This may involve doubling the spatial pooling amount or moving to the “next size up” among a library of implementable spatial pooling configurations. Then go to Step 1B.2 and re-evaluate temporal pooling levels with the new selected spatial pooling amount for evaluation. If we are currently already at the maximum possible spatial and temporal pooling amounts, then the algorithm fails.

The above implementation of Step 1B may be modified any number of ways: The condition “mu>sigma” may be computed by actually measuring the optical flow value, or it may be predicted based on what information is currently available about the environment (e.g. brightness) and on the currently known motion of the vision system and/or objects in the environment being observed, or a combination thereof. For example, if the vision system is on a UAV platform that is about to undergo an aggressive maneuver, it may be beneficial to consider the faster imagery that will result when selecting a temporal pooling amount. It may also be beneficial to vary spatial and/or temporal pooling amounts depending on knowledge of the visual texture being observed. For example, more spatial and/or temporal pooling may be needed if the contrast of the imagery in the environment decreases.

Handling Self Motion

One significant problem when performing vision from a moving UAV is that of handling motion blur or visual smearing that may occur as a result of the UAV's rotation and translation. This problem is discussed at length in U.S. Pat. No. 7,659,967 by Barrows and Neely entitled “Translational optical flow sensor”. Two solutions to this problem, for environments that are not photon limited, are presented in two US patent applications by Barrows, application Ser. No. 12/852,506 entitled “Visual motion processing with offset downsampling” and application Ser. No. 13/756,544 entitled “Method to process image sequences with sub-pixel displacements”. These patent applications are incorporated herein by reference.

Incorporating Intertial Information

Suppose the camera system is mounted on a moving platform, such as a mobile robot or an air vehicle. Such platforms may undergo exaggerated motion as they move throughout the world. Such motions may include both rotation and translation. It is well understood that such motions tend to “blur” the acquired imagery from cameras, because the receptive fields of individual pixels may shift rapidly over a single temporal integration period. It is well understood that angular rotations tend to have a particularly dramatic effect. These motions force the camera system to use a shorter integration period, so that the photons acquired by a single pixel are from a single direction. This may limit the use of temporal pooling. Therefore it is desirable to find a way to implement temporal pooling while the platform is undergoing motion.

When using SPAD circuits, it is possible to use techniques inspired by the concept of “offset downsampling” as depicted in the aforementioned patent application Ser. No. 12/852,506. This is because the binning method to form superpixels, as taught in that patent application, are similar to spatial summation. Essentially one may shift the locations of the analogous super pixels to compensate for rotation.

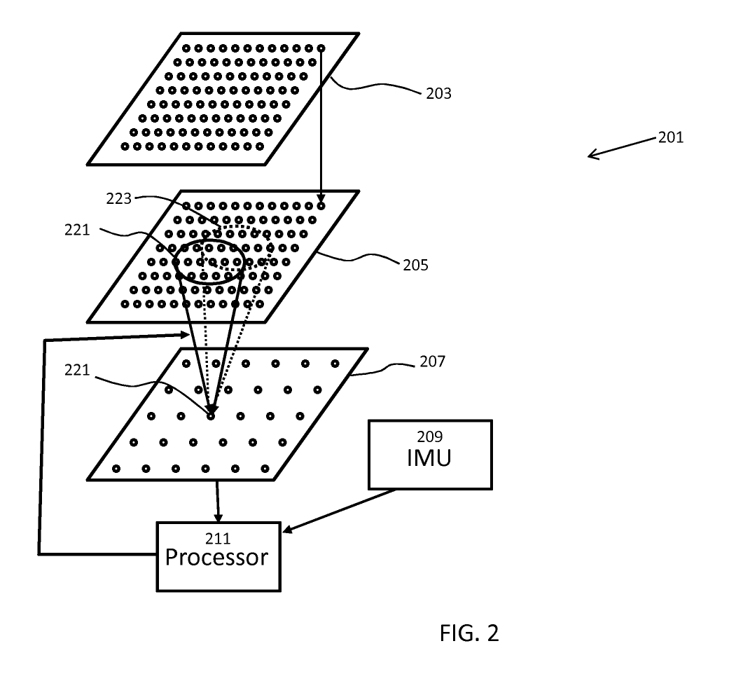

Refer to FIG. 2, which depicts a vision system 201 for sensing the environment using shiftable receptive fields. The vision system of FIG. 2 is much like that of FIG. 1A, and includes a lens (not shown), an array of SPADs 203, an array of photon counting circuits 205, and an array of pooling mechanisms 207. However there is also an inertial measurement unit (IMU) 209, and a processor 211. The IMU would comprise an angular rate sensor such as a gyro, and may comprise an accelerometer as well. The IMU 209 may even incorporate other knowledge of self-motion or ego-motion so as to better determine how the receptive fields may be shifted. The processor 211 monitors the IMU and may also perform image processing on the images generated by the array of pooling mechanisms. Furthermore, the processor is able to change the location of the receptive fields. For example, the receptive field 221 of pool mechanism 222 could be moved or shifted to a new location 223 or to many other locations (not shown). The receptive fields of other pooling mechanisms may be shifted in a similar manner. The benefit of this approach is that the accumulated photons in a receptive field will cover a longer time period than what is possible without using shiftable receptive fields, which gives the same benefits as temporal pooling including enforcing the “mu>sigma” condition.

Suppose the vision system of FIG. 2 were mounted on a UAV undergoing rotation. The vision system of FIG. 2 may operate in the same manner as the vision system of FIG. 1A, including its variations thereof, with one additional modification: The locations of the receptive fields may change in response to detected visual motion. For example, suppose the processor and the IMU determines that the UAV has rotated in a manner that would cause the image presented at the SPAD array to shift right by a pixel. The processor can then move the receptive fields of the pooling mechanisms so that the receptive fields continue to point to the same direction or region of the visual field to counteract or minimize the effects of the rotation. For example, a pooling mechanism that responds to rows 1 through 10 and columns 1 through 10 of the SPAD array may be adjusted to respond to rows 1 through 10 but columns 2 through 11 of the SPAD array. The amount of motion of course determines on the measured angular motion and the geometry of the optics of the vision system. For example, if the vision system uses optics with an effective focal length of 2 mm, and the raw pixel pitch on the focal plane is 20 microns, and the angular motion between two frames or two cycles is 0.02 radians, then the rotation induced optical flow is 2 mm×0.02 radians=0.04 mm=40 microns on array 203, or two pixels. In this case the receptive field should be shifted by two pixels to compensate for rotation. Optionally, fractional shifting amounts may be implemented using techniques of bilinear interpolation, which are well understood in the field of image processing.

If the UAV continues to rotate, so that the image on the SPAD array continues to shift, the processor may continue to move the receptive fields of the pooling mechanisms accordingly. In this manner, each pooling mechanism may continue to accumulate photon counts from the same direction. When temporal pooling is additionally applied, the pool signal generated by the pooling mechanism will depend on the history of the pool sums. Even when the UAV has rotated through a large angle, the history of pool sums will be derived from the same direction in the visual environment, and will be similar to that obtained if the UAV were not in motion. Thus this technique can allow increased light sensitivity in dark environments and thus achieve “mu>sigma” even when the UAV is undergoing large rotations. This technique can also be combined with active illumination including pulsed LEDs to a great effect.

If the angular rotations of the UAV are adequately large, it may be useful to also adjust the shape and/or size of the receptive fields of each pooling mechanism to account for any known optical distortion, for example barrel, pincushion, or fisheye distortion, caused by the optics.

In some cases, the UAV may be translating instead of or in addition to rotating. In this case, the IMU alone may not provide enough information to perfectly remove the effects of motion. However, it may be possible, through processing the imagery generated by the pooling circuits or by some other means, to know exactly how much the image is shifting on the SPAD array. In this case, the shifting of the pooling circuits can be performed according to this knowledge rather than by just the IMU.

Using Active Pixel Sensor (APS) Circuits

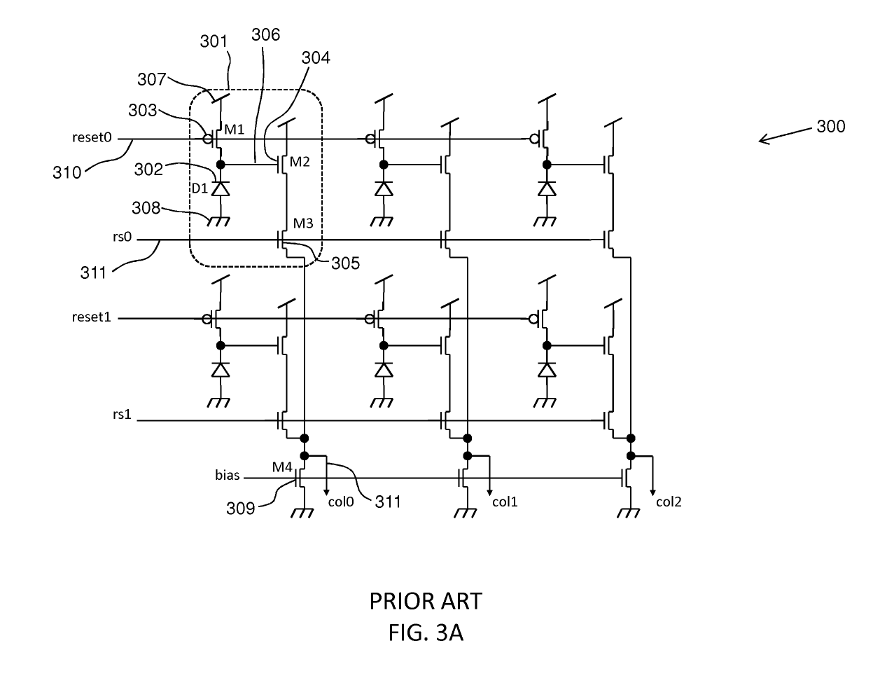

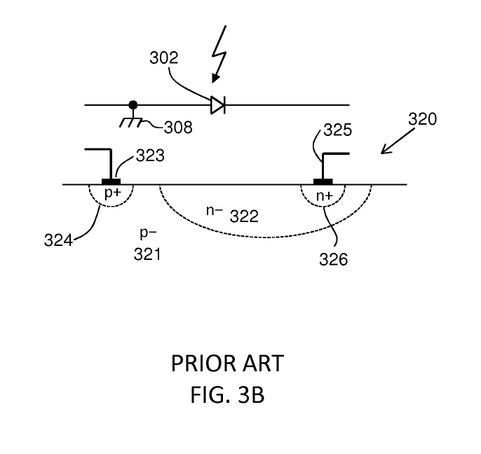

It is also possible to use active pixel sensor (APS) circuits instead of SPAD circuits to implement a vision system capable of providing image sensing to allow flight in the dark. Refer to FIG. 3A, which depicts an active pixel sensor (APS) focal plane array 300. Focal plane array 300 may be implemented in a monolithic integrated circuit. The operation of focal plane array 300 is well-known and understood in the art of image sensor circuits. One pixel circuit 301 of the array comprises photodiode D1 302 and transistors M1 303, M2 304, and M3 305. Transistor M1 303 may be a P-channel MOSFET, while transistors M2 304 and M3 305 may be N-channel MOSFETs. Transistors M1 303 and M2 304 and photodiode D1 302 connect together at node 306. The potential at node 306 may be referred to as the potential of pixel circuit 301. The pixel circuit 301 operates as follows: When signal reset° 310 is set to digital low, node 306 is charged to the potential of a power source 307. Then signal reset° 310 is set to digital high. When light strikes photodiode D1 302, current flows from node 306 to ground 308, which lowers the potential at node 306. After a predetermined time interval, signal rs0 311 may be set to digital high. This connects transistor M2 304 to transistor M4 309 via transistor M3 305. Transistors M2 304 and M4 309 may then form a source follower, which allows the potential at node 306 to be read out at column signal col0 311. The signal read out depends on both the amount of light striking photodiode 302 and the time interval (referred to as the “integration interval”) between when signal reset° 310 is set to digital high and signal rs0 311 is set to digital high. It is beneficial to set the time interval short enough so that node 306 does not discharge all the way (a condition known as “saturation”), but long enough so that change in potential at node 306 may be measured.

Multiple copies of pixel circuit 301 may be arranged in a one dimensional array (not shown) or the two dimensional array 300 shown in FIG. 3A. Although a 2×3 array is shown in FIG. 3A; a larger array size may be used. The column signals (e.g. col0 311) may be connected to the respective transistors M3 of each pixel circuit of one column of array 300 as shown. The row select signals (e.g. rs0 311) may be connected to the respective transistors M3 of each pixel circuit of one row of array 300 as shown. This allows the row select signals to read out the potential of the pixel circuits from one row of array 300 onto the column signals. A multiplexer circuit may then be used to select one of the column signals for output.

The operation of focal plane circuit 300 is well known in the art of image sensors and may be performed in different ways. For example, the reset signals of all rows may be pulsed low and then high at the same time. Then after an integration period the individual rows may be read out in rapid sequence. Alternatively a “rolling shutter” method may be used. Details and examples may be found in the book “CMOS Imagers: From Phototransduction to Image Processing”, edited by Yadid-Pecht and Etienne-Cummings and published in 2004. The contents of this book are incorporated herein by reference.

It may be beneficial to design focal plane array 300 so that it is optimized for low light environments. First, it may be beneficial to select sizes for photodiode 302 as large as possible, so that more photons may be captured. As suggested above, this may involve designing pixel circuits to have a pitch of 25 microns, 50 microns, or even more, or to have an angular pitch of one or more degrees per pixel once optics are added. Second, it may be beneficial to reduce the total parasitic capacitance in the circuit 301 at node 306. This may be performed by reducing the sizes of transistors M1 303 and M2 304 to minimize parasitic capacitance. This may be performed by selecting a structure for photodiode 302 that has a smaller parasitic capacitance per area. There are two benefits of reducing parasitic capacitance: First, fewer photons need to be captured by the photodiode 302 to obtain a measurable potential. Second, the Nyquist-Johnson noise at node 306 may be reduced as well, when measured in electrons. It will be understood that all capacitors have Nyquist-Johnson noise, and that although this noise decreases in potential as the capacitor increases in size, this noise actually increases in charge (e.g. in electrons) as the capacitor increases in size. Thus if it is desirable to measure very small charges, a smaller parasitic capacitance may be preferred.

The above-described “mu>sigma” condition may be defined for APS-based vision systems similarly as it was for SPAD-based systems above. The value “mu”, again, would refer to the “ideal” signal that results when noise is not present. The value “sigma” would be the sum of all noises, which may reflect the standard deviation of the Poisson random variable determining the number of photons arriving at a photodiode over a time interval as well as dark current noise e.g. the standard deviation of dark current and the presence of any Nyquist-Johnson noise, for example across the photodiode or in the transistors forming the pixel readout circuit.

For the photodiode 302, it may be beneficial to use an N-Well photodiode structure. Refer to FIG. 3B, which depicts an N-Well photodiode 320 that may be used for photodiode 302. The photodiode junction is formed between a P-substrate 321 and an N-well 322. The P-substrate may be tied to ground 308 through a P-contact 323 made with P-diffusion 324. This shorts the cathode of photodiode 302 to ground 308. The anode of photodiode 302 may be connected to node 306 (not shown in FIG. 3B) through N-contact 325 made with N-diffusion 326 inside the N-well 322. The light doping of the P-substrate 321 and N-well 322 reduces the capacitance at the junction between these two layers, and thus reduces the parasitic capacitance of photodiode 302. It will be understood, however, that other types of photodiode structures may be used than the N-well structure shown in FIG. 3B.

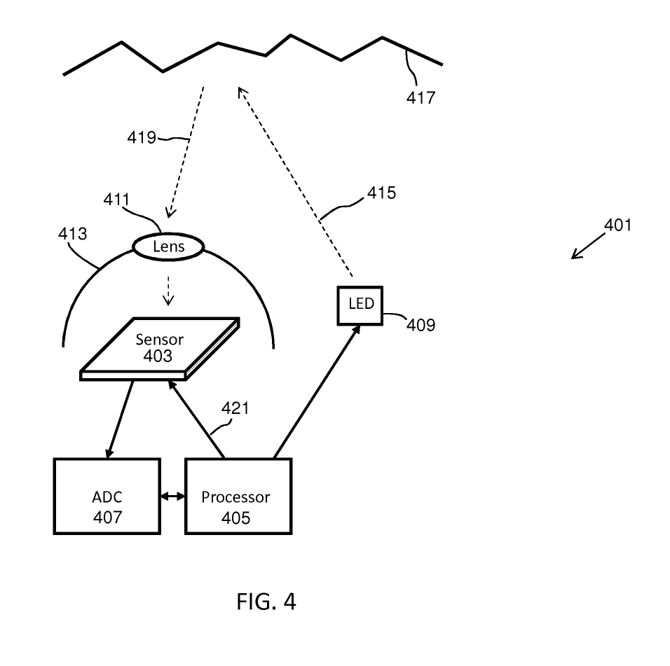

Refer to FIG. 4, which depicts a vision system using active illumination 401. The vision system 401 comprises an image sensor 403, a processor 405, an optional analog to digital converter (ADC) 407, an LED 409, a lens 411, and an optional enclosure 413. The image sensor may be a monolithic integrated circuit that contains focal plane array 300. The processor 405 operates LED 409 so that it projects light 415 out onto the environment 417. Reflected light 419 from the environment 417 then travels back to the vision system 401. The light 419 passes through the lens 411, which focuses the light onto the image sensor 403. The optical enclosure 413 ensures substantially that the only light striking the image sensor 403 is through the lens 411. The processor 405 operates the image sensor 403 to acquire image information, and then processes the information. The Processor 405 may acquire image information directly from the image sensor 403, or it may acquire information from the image sensor 403 via the ADC 407. In alternative variations the ADC may be embedded in the processor 405 or it may be embedded on the image sensor 403. Whether or not an ADC is required depends on the nature of the image sensor, including whether SPADs and respective readout or binning circuits are used and whether they operate digitally or analog. Generally if the output of the image sensor 403 is analog, then ADC 407 is beneficial. The signal 421 from the processor 405 to the image sensor 403 may include signals such as reset signals (e.g. reset0 310) and row select signals (e.g. rs0 311).

The basic operation of focal plane circuit 300 may be performed as follows. Let us first discuss when using active illumination:

Algorithm 3:

Step 1: Reset the focal plane array on the image sensor 403 by setting all reset signals (e.g. 310) to digital low and then to digital high.

Step 2: Turn on the LED 409 for a very short period, such as a microsecond or a millisecond or another value.

Step 3: Turn off the LED 409.

Step 4: Using the row select lines (e.g. 311), read out the node potential (e.g. potentials at 306) for each pixel circuit. The potentials may be digitized with ADC 407.

Step 5: (Optional) If desired, implement spatial pooling in software on the processor 405 by averaging together the values associated with local blocks of pixels. It is also possible to implement temporal pooling by averaging these values over multiple frames.

Step 6: Generate one or more output images based on the acquired images. Perform any other desired image processing algorithms on these output images. This may include, for example, algorithms to measure optical flow.

Step 7: Optionally delay a small amount.

Step 8: Go to Step 1.

As described above, if active illumination (e.g. LED 409) is used, it may be beneficial for the duty cycle of LED 409 (the fraction of time that the LED is on) to be small, so as to reduce the effects of dark current in the photodiodes. If no active illumination is used, Steps 2 and 3 may eliminated, and replaced with a single step of providing adequate delay to allow accumulation of charge in the pixel circuits.

When performing Step 5, it may be beneficial to account for self motion of the vision system, in a manner similar as that described in FIG. 2 above. In this case, the “blocks” of pixels that are summed together may be shifted each cycle of the algorithm, with the block sums accumulated, which would implement the aforementioned concept of movable receptive fields. The amount of shifting may be computed using the output of an IMU, also as described above.

All of the above methods for processing photon-limited images acquired by SPADs may be applied to images acquired with APSs, with the same general goal of obtaining “mu>sigma”. This includes the following: Applying spatial and/or temporal pooling, dynamically varying the spatial and/or temporal pooling amounts to obtain “mu>sigma” as the environment changes or as the scenario changes, using knowledge of self-motion to modify spatial and/or temporal pooling amounts, varying the time period over which the LED is illuminated based on the environment or self-motion, and the technique of using movable receptive fields to increase temporal pooling while the system is in motion. The main difference is that APS circuits may generally output either charge values or voltage potentials, while SPADs may generally output individual photon counts.

Variations to the Active Pixel Circuits

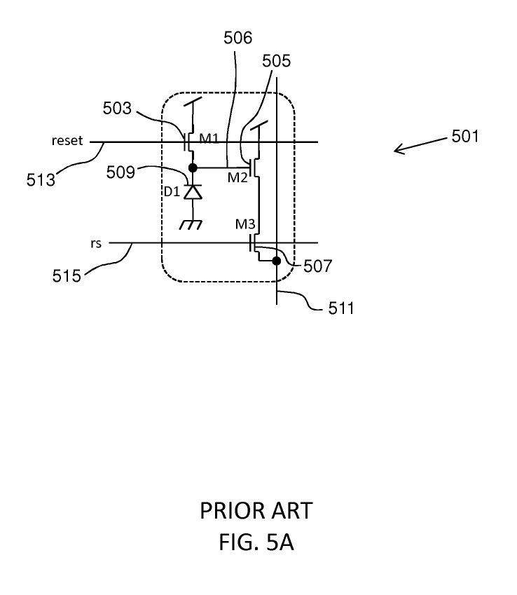

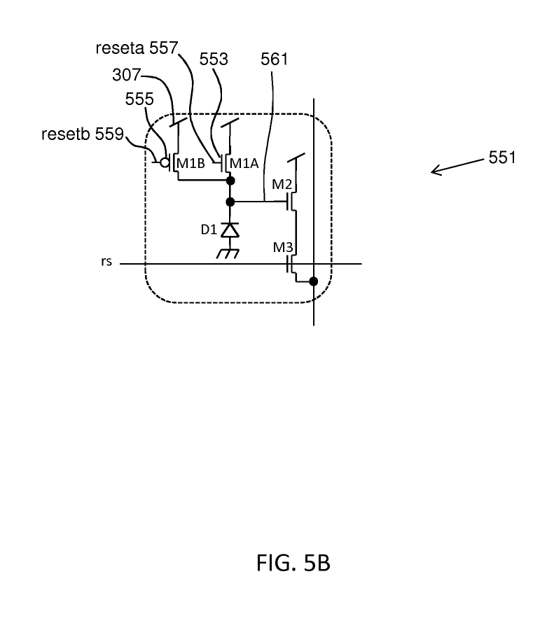

Variations to the active pixel circuits (e.g. 301) are possible. Refer to FIG. 5A, which depicts an active pixel sensor (APS) circuit using just N-channel MOSFETS 501. Circuit 501 comprises node 506, transistors M1 503, M2 505, and M3 507 and photodiode D1 509 which may be connected in the same manner as circuit 301. Transistor M3 507 connects to a column readout line. Input signals reset 513 and rs 515 respectively reset and read out the potential at node 506. The difference between this circuit and the circuit 301 is that transistors M1 503, M2 505, and M3 507 are N-channel MOSFETs. Thus, to reset the potential at node 506, the reset line 513 is first set to digital high and then set to digital low, which is the opposite as that for circuit 301.

An advantage of circuit 501 is that since transistor M1 503 is an N-channel MOSFET, when signal reset 513 is set to digital high, the voltage drop across transistor M1 503 settles to a logarithmic value of the current flowing through photodiode D1 509. In this case, circuit 501 becomes a logarithmic photoreceptor. The implementation and operation of logarithmic photoreceptors is discussed further in the aforementioned U.S. patent application Ser. No. 13/078,211 by Barrows et al. This allows a first image to be read out from an array of circuits 501 in logarithmic mode to determine overall intensities, after which the integration interval may be selected. This is further discussed in the algorithm below, which may be performed with an image sensor having an array of circuits 501 of the type shown in FIG. 5A.

Algorithm 4:

Step 1: Set all reset signals (e.g. reset 513) to digital high.

Step 2: Wait to allow the pixel circuits to settle e.g. to allow the potentials at node 506 to settle for all pixels. This may take between a few microseconds and a few tenths of a second depending on the visual environment.

Step 3: Using the row select signals (e.g. rs 515), read out the potentials at each pixel. This may be performed using an ADC and a processor. It may be beneficial to also correct for fixed pattern noise or offset, as described in the aforementioned U.S. patent application Ser. No. 13/078,211 by Barrows et al.

Step 4: Based on the measured light levels, determine whether or not the LED 409 is to be used and how long the integration interval will be. If the LED 409 is not to be used, generally a longer integration period may be beneficial if the light levels are lower. It may also be beneficial to turn on the LED 409 if other available knowledge of the environment indicates this may be necessary.

Step 5: Set all reset signals (e.g. reset 513) to digital low.

Step 6: If the LED 409 is to be used, turn it on

Step 7: Delay for selected integration interval.

Step 8: If the LED 409 is on, turn it off

Step 9: Using the row select lines (e.g. 515), read out the node potential (e.g. potentials at 506) for each pixel circuit. The potentials may again be digitized with an ADC 407 connected to processor 405.

Step 10: (Optional) If desired, implement spatial and/or temporal pooling in software by averaging together the values associated with local blocks of pixels or over multiple frames. As described above, this step may incorporate shifting the pool's receptive fields to account for self motion as described above.

Step 11: Generate one or more output images based on the acquired images. Perform any other desired image processing algorithms on these output images. This may include, for example, algorithms to measure optical flow.

Step 12: Optionally delay a small amount.

Step 13: Go to Step 1.

Refer now to FIG. 5B, which depicts a multi-mode active pixel sensor (APS) circuit 551. This circuit 551 is similar to circuits 501 and 301 except that transistor M1 (503 or 303) is replaced with transistors M1A 553, an N-channel MOSFET, and M1B 555, a P-channel MOSFET. Transistor M1A 553 is operated by signal reseta 557 and transistor M1B 555 is operated by signal resetb 559. To implement Algorithm 4 using circuit 551, the following changes may be made to Steps 1 and 5:

Step 1: Set all signals reseta (e.g. 557) and resetb (e.g. 559) to digital high.

Step 5: This step is now broken down into three sub-steps:

Step 5A: Set all signals reseta (e.g. 557) and resetb (e.g. 559) to digital low.

Step 5B: Wait a short duration for the potential at node 561 to reach the power supply 307 potential. This may take a fraction of a microsecond.

Step 5C: Set all signals resetb (e.g. 559) to digital high.

An advantage of circuit 551 over circuit 501 is that in Step 5, the potential at node 561 will be set to the power supply 307 potential, rather than that potential minus a voltage drop across transistor M1 503. This allows for a larger voltage swing, which increases the dynamic range of the image sensor.

Other variations to the basic active pixel circuit (301, 351, or 501) are possible. For example, U.S. Pat. No. 8,426,793 entitled “Vision Sensor” by Barrows discloses an image sensor with circuits that automatically adjust the integration period of photodiodes according to the light intensities. Such techniques may be utilized in image sensor 403 and may be beneficial in preventing the pixel circuits from saturating if the LED 409 is too bright for a particular environment, for example if the environment 417 is too close to the vision system 401. Similarly, binning techniques such as those described in the aforementioned patent application Ser. No. 13/078,211 by Barrows et al may be used as well, in which case pooling and spatial summation are performed on the image sensor 403.

Another variation is to use the image acquired when the active pixel circuits are operated in logarithmic mode to modulate the integration period, e.g. the delay in Step 7, so that longer integration periods are used when the visual environment is detected to be darker. This may occur with or without the LED being turned on, including with the LED optionally turned on in Step 2.

Another variation is to use an image sensor constructed from pixels of the type shown in FIGS. 5A and 5B, but to operate the entire array in either logarithmic mode or in linear mode. In this case, “crossover” algorithms may be utilized to determine which of the two modes is appropriate, based on available light levels. In lower light environments, the linear mode may be used. In brighter environments, the logarithmic mode may be used. There may be a middle region of light levels in which either mode may be used. For purposes of continuity, when the environmental light levels are in the middle region, the mode being used may be selected to be consistent with that of previous acquired frames.

In some cases, it may be desirable to acquire imagery using just the linear integration mode, for example when low contrast texture needs to be analyzed. In this case, techniques to automatically adjust the integration period may be utilized. This includes techniques taught in U.S. Pat. No. 8,426,793, by Barrows and entitled “Vision Sensor”, issued on Apr. 23, 2013, and the contents of which are incorporated herein by reference. When using such techniques, imagery may be acquired by APS pixels for as long an integration period is needed. However when light levels are adequately high, the image sensor will stop integrating once one of the pixels approaches saturation.

Multiple Pooling Configuration Variations

The above teaching provided primarily examples in which one temporal pooling configuration and/or one spatial pooling configuration were applied across the entire vision system. It will be understood that it is possible to use different pooling configurations in different portions of the visual field. Such approaches may be appropriate if, for example, the visual environment in one direction is several orders of magnitude brighter than in another direction or if it is known there are nearby objects in one direction that may benefit from illumination.

It will be understood that several parallel sets of pooling mechanisms may be applied to the same portion of the visual field, each with different pooling configurations. For example, suppose a region of the visual field contains mostly dark texture, with one or two bright points of light. In this case one set of pooling mechanisms may apply longer temporal integration periods and larger spatial pooling fields to achieve “mu>sigma” over the entire visual field, and another sert of pooling mechanisms may use shorter temporal integration periods and smaller spatial pools to localize the points of light with greater precision.

Both of the above variations may be applied to SPAD-based pixel circuits or APS-based pixel circuits or any other type of pixel circuit.

Multiple Aperture Variations

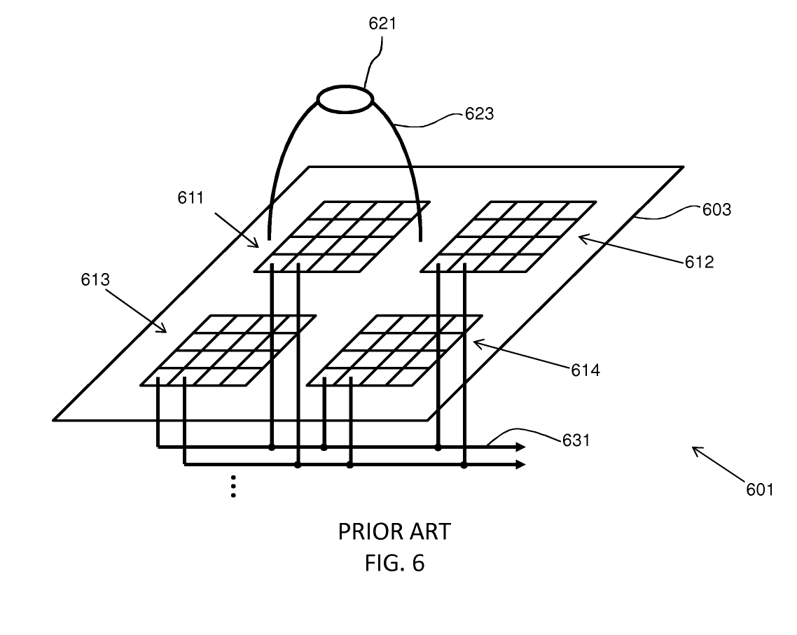

In some cases, the environment may be so dim that alternative optical techniques may be desirable to increase the number of photons detected. Refer to FIG. 6, which depicts an exemplary multiple aperture camera 601. Camera 601 comprises a multiple array image sensor 603. In FIG. 6, four arrays are shown (e.g. 611, 612, 613, 614) located on image sensor 603, though more or fewer arrays may be used. Each of these arrays may be a focal plane circuit, for example focal plane circuit 300 or its variations or an array of SPAD circuits (103 or 203) and any binning or pooling mechanisms. Each of these arrays may be separate, distinct arrays, as shown in FIG. 6, or may be different non-overlapping sections of one larger focal plane array (variation not shown). Each focal plane circuit (e.g. 611 through 614) may then be provided with its own lens and optical enclosure. For example, lens 621 allows light from the environment to illuminate focal plane circuit 611, while optical enclosure 623 ensures substantially that the only light striking focal plane circuit 611 is through lens 621. Each of the other focal plane circuits has their own lens (not shown) and optical enclosure (not shown). It is beneficial for the four arrays to be optical isolated from each other, so that light traveling through one lens only reaches the array associated with that lens.

It is beneficial for the individual focal plane circuits and their respective lenses to be aligned, including setting to be the same the distance between each lens and its respective focal plane circuit. In this case, the images landing on the focal plane circuits will be substantially identical, especially if the environment is far enough away that stereo disparity effects are negligible. In this case, these images may then be directly added together. For example, the lower left pixel of each focal plane circuit may be added together to form signal 631, and so forth. If the focal plane circuits utilize SPADs, this addition may be performed as literal additions, or pulses from corresponding SPAD circuits may be connected together with OR gates. If the individual pixel circuits output analog values, then these analog values may be summed on the chip before digitization, or the individual pixel outputs may first be digitized with an ADC and then the respective values summed arithmetically on a processor.

The net effect of summing the individual images is to increase the effective F-stop of the vision system. For example, if each lens (e.g. 621) has an F-stop of 4, then using four such lenses as shown in FIG. 6 increases the light gathering by a factor of four, which results in an approximate effective F-stop of 2. If the number of focal plane circuits and lenses is further increased, say to a 10×10 array rather than the 2×2 array shown, the effective F-stop of the camera can be many times better than “one”. Decreasing the F-stop of the system, by increasing the total amount of light gathered, also has the effect of improving the SNR by increasing “mu” relative to “sigma”. Thus, this is another technique that may be used to achieve “mu>sigma”.

As described above, it is beneficial for the individual focal plane circuits and their respective lenses to be aligned. If this is not the case, however, it is still possible to combine the images from the individual focal plane circuits into one image. In this case, it may be beneficial to use image warping to mathematically align the images together before summing Such image warping techniques are well-known and an established art in image processing.

Other variations are possible. For example, rather than lenses, one may use binary optics, such as the printed pinhole optics disclosed in U.S. patent application Ser. No. 12/710,073 entitled “Low Profile Camera and Vision Sensor” by Barrows, filed Feb. 22, 2010, the contents of which are incorporated herein by reference. In this case, each of the focal plane circuits (e.g. 611 through 614) may be associated with its own printed pinhole (or other aperture). It may be possible to dispense with the optical enclosures (e.g. 623) due to Snell's window effect. One may also use the teachings of U.S. patent application Ser. No. 13/048,379 entitled “Low Profile Camera and Vision Sensor” by Barrows, filed 15 Mar. 2011, the contents of which are incorporated herein by reference. In this case, optics embedded within the image sensor optics, for example using the techniques shown in FIGS. 23-26 of application Ser. No. 13/048,379.

Coded Aperture Arrays

Another technique to increase the amount of light being gathered is to use coded aperture arrays. Such arrays were first disclosed in U.S. Pat. Nos. 4,209,780 and 4,360,797, both entitled “Coded Aperture Imaging with Uniformly Redundant Arrays” by Fenimore and U.S. Pat. No. 4,389,633 entitled “Coded Aperture Imaging with Self-Supporting Uniformly Redundant Arrays”, also by Fenimore. These three patents are incorporated herein by reference. Other types of coded aperture structures that are known in the art may be used as well. These three patents disclose a camera structure where the optics is implemented with a binary optic sheet having a predetermined pattern, and is matched to an array of detectors having the same dimensions. As radiation passes through the coded aperture, it illuminates the array of detectors in a way that implements an optical convolution between the visual field and the coded aperture. The image acquired at the detectors is then processed to extract the original image. The main advantage of this method is that the effective F-stop can be quite small without having to use refraction.

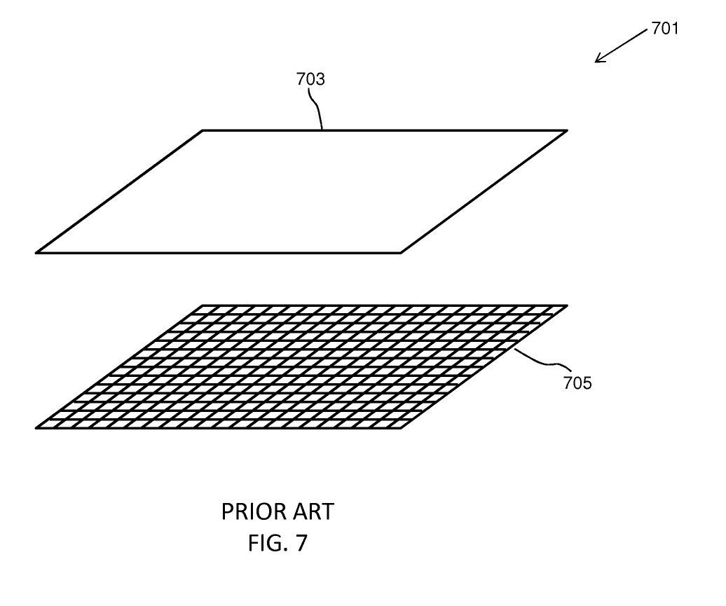

Refer to FIG. 7, which depicts a coded aperture array camera 701 of the type that may be used in the present teachings. This camera comprises a coded aperture 703 and a focal plane circuit 705. An optical enclosure (not shown) may ensure that the only light striking the focal plane circuit 705 is through the coded aperture 703. The coded aperture 703 may have a pattern of the type taught in the aforementioned patents by Fenimore. It is beneficial for the pixel geometry in the focal plane 705 to match up to the geometry used in the coded aperture 703 so that they have the exact same size and are aligned. A processor (e.g. 405) would acquire the light patterns striking the focal plane 705, and then perform any computations necessary to reconstruct an image of the environment.

It will be understood that the use of coded aperture arrays may be combined with any of the techniques already discussed above. For example, an extremely sensitive vision system may be implemented by using a multiple aperture array, such as that shown in FIG. 6, in which each focal plane circuit uses SPAD circuits, and in which each lens (e.g. 621) is replaced with a coded aperture array of the type shown in FIG. 7, and by using spatial and temporal summation also as described above. Such a circuit may be used with or without active illumination.

It will be understood that in such implementations, the output of a single physical pixel on the focal plane 705 will comprise light from a variety of angles, and the output of a final computed pixel will comprise information from a collection of physical pixels. Therefore the effects of noise may be amplified. Therefore, such techniques may be best suited for when the visual environment is substantially dark except for small regions of the visual field which contain the majority of the light. This may include, by way of example, a dark sky with illumination coming from distant air vehicles that may show up as comparatively bright points against the dark sky.

Linear Arrays

It will be understood that all the above techniques may be used to implement one dimensional arrays in addition to two dimensional arrays. In the case of one dimensional arrays, the pixel circuits, whether implemented with SPADs or active pixel sensors or other, may be substantially rectangular shaped, for example as disclosed in U.S. Pat. No. 6,194,695 entitled “Photoreceptor Array for Linear Optical Flow Measurement” by Barrows. In this case, any optics used may be selected to match the rectangular shape of the photoreceptors, for example by using slit apertures instead of pinholes. This allows more light to reach the photodetectors. The outputs of such pixels or pools may be fed to one dimensional optical flow algorithms, including the aforementioned algorithm by Horridge.

A variation of this approach is to use a substantially two dimensional pixel array, but generate substantially rectangular pools from the two dimensional pixel array. This technique allows the implementation of spatial pooling while retaining spatial resolution in a desired direction.

Applications to Controlling a UAV

One application of the above teachings is to build a vision system that allows a small air vehicle to hover in place in low light environments. In the aforementioned patent application Ser. No. 13/078,211 entitled “Vision Based Hover In Place” by Barrows, in FIGS. 16A to 17, discloses an array of cameras arranged to acquire imagery over a wide field of view from a helicopter. FIG. 18A of that patent application then discloses an algorithm that can use the acquired imagery to enable the helicopter to hover in place using visual information. It will be understood that the above teachings may be used in combination with the teachings of this patent application to allow the helicopter to hover in extremely low light level environments. Essentially the vision system would incorporate SPAD-based pixel circuits or APS-based pixel circuits or other pixel circuits, whose raw pixel outputs are processed using pooling mechanisms to produce pixel signals that satisfy the “mu>sigma” condition for the present environment. These pixel signals may then be processed using method described in the aforementioned patent application, including optical flow based methods, which may then be used to stabilize the helicopter using visual information. It would be beneficial for such a visual system to acquire imagery over a large field of view as described in the aforementioned patent application to maximize the chance that visual texture is detected and tracked.

The teachings in the aforementioned patent application Ser. No. 13/078,211 may be expanded upon. Most air vehicles generally have an IMU including a gyro for stability. This gyro may be incorporated into the camera system as taught above. For example, the aforementioned technique of using movable receptive fields may be used to reduce the effects of angular rotation, and thus allow an increased amount of temporal pooling to increase the SNR and improve position hold, even when the air vehicle is undergoing strong rotations. In another variation, the IMU may be used to stabilize the air vehicle as part of a faster, inner control loop. The implementation of such pose-control techniques using a gyro and an accelerometer is a mature and well-known technique in the field of helicopter and quadrotor stabilization. With the pose stabilized, temporal pooling may be applied to increase the SNR of the pixel signals used for position hold. If pose control is adequate, it may even be possible to avoid use of movable receptive fields. Either method may be used to establish the “mu>sigma” condition and thus allow the visual environment to be observed. The imagery acquired by the camera system, including any pooling mechanisms, may then be used to stabilize the position of the air vehicle using techniques described in the aforementioned patent application Ser. No. 13/078,211.

When using such vision systems on an air vehicle for stability and other tasks, it is beneficial to for the camera system to have an extremely wide field of view, for example as described in the aforementioned patent application Ser. No. 13/078,211. A field of view of at least 180 degrees, or 2π steradians, including up to a full omnidirectional field of view, may be beneficial. Such a wide field of view both increases the number of photons accumulated from the visual field, and increases the chance that texture will be found that may be visually tracked for stability purposes. Although a wide field of view is beneficial, it is for some tasks, for example hovering in place, permissible for there to be gaps in the field of view. A vision system that covers, for example, a 180 degree field of view except for a few gaps inside this range is said to “span” the 180 degree field of view. It is also permissible, for some tasks such as hovering in place, for the field of view to be substantially horizontal. In this case, various ego motion measurements may be obtained and controlled as taught in the aforementioned patent application Ser. No. 13/078,211.

As described above, studies of the visual systems of flying insects have yielded clues to the required pixel resolution to perform flight control tasks such as hover in place and obstacle avoidance, which have been further backed up by experimental results obtained by the present inventor. We know through experience that the techniques taught in the aforementioned patent application Ser. No. 13/078,211 may be used to achieve hover in place using just several hundred pixels, with a pixel pitch of three or four or more degrees between each pixel, in particular if these pixels are distributed in a fashion to span most of the horizontal yaw plane. The pitch between pixels may be on the order of between two degrees to as much as 25 degrees or more. These values present an example of the amount of spatial pooling that may be obtained, since the outputs of pooling mechanisms are effectively pixel signals that may then be processed for flight control. Similarly, if the platform's pose is stabilized using an IMU, or if the technique of movable receptive fields is used to counteract the effects of rotation, temporal pooling as much as a few tenths of a second may be used to control the drift of the air vehicle. The construction of spatial-temporal pools covering five to 25 degrees and a few tenths of a second allows for increased accumulation of photons for perceiving the environment by ensuring in general that “mu>sigma” for the pixel signals generated by the pools. Suppose, therefore, that a vision system on an air vehicle has a pitch of 1 degree between adjacent pixels and a maximum frame rate of 100 Hz. If the pixel pitch is 20 microns, this would correspond to a lens having a focal length of a little over a millimeter. This would correspond to a count of about 40,000 raw pixels over the entire spherical field of view, or a total of about 4 million pixels sampled per second. If the air vehicle is flying in an environment that is adequately bright that “mu>sigma” for the raw pixels, and if the processing on the air vehicle is able to process 4 million pixels per second, then it is not necessary to apply spatial or temporal pooling. However suppose that the light levels drop so that the “mu>sigma” condition is no longer met. Temporal pooling may be applied, either by integrating photons or photocurrent for longer periods of time, up to several tenths of a second. Similarly spatial pooling may be applied to generate pools have a size of 5 to 25 degrees. The photon rate experienced at the pool level, after summation by spatial and temporal pooling, may be several hundred to ten thousand or more times that experienced at the raw pixel level. Thus the SNR may be increased by up to a hundred or more, allowing for “mu>sigma” to be obtained in light levels orders of magnitude darker than that possible using just the raw pixels.

Of course, this same result may be obtained by using a camera system having larger photodiodes for light detection. Instead of raw pixel pitches of 20 microns when using 1 mm focal length cameras, the pixel pitches may be increased to 125 to 500 microns. Such a system would be simpler to process and operate, but of course would not have the ability to acquire higher resolution images that may be useful for other applications.

Another variation is to use two sets of spatial pooling mechanisms, with the first set of pooling mechanisms having a substantially horizontal rectangular shape and the other set of pooling mechanisms having a substantially vertical rectangular shape. The outputs of these two sets of pooling circuits may be used to respectively compute vertical optical flow and horizontal flow, which may then be used to stabilize or control a UAV using aforementioned techniques.

An additional benefit may be realized by using active illumination for the direct detection of obstacles. When in a pure dark environment, e.g. an environment with no substantially ambient illumination (other than that provided by the LED e.g. 151), a nearby illuminated obstacle will have an apparent brightness proportional to its surface reflectance (albedo) divided by the square of the distance between the vision sensor and the surface being observed. Thus even nearby objects having a low albedo may appear substantially brighter than the background in the presence of active illumination. Therefore it may be possible to provide an air vehicle with the ability to avoid obstacles simply by turning away from directions of the visual field occupied by brightly illuminated objects. When in an environment that has some ambient light, the same principle may be exploited by grabbing two sequential frames, one with the LED on and one with the LED off. Then nearby objects may be found by looking for regions of the visual field with the largest intensity changes due to the LED turning on.

It is also possible to extend this principle further and obtain an estimate of time until collision while the air vehicle is in motion. Since the brightness of an object due to active illumination (or change in brightness resulting from the active illumination turning on) is proportional to the inverse square of the distance, when the distance to the obstacle is halved, its apparent brightness is quadrupled. Thus if the object took T seconds to increase in brightness by four, if the air vehicle continues to travel in the same direction it is in danger of crashing into the object in another T seconds. In greater detail, suppose that an object being observed increases in intensity from I₁ to I₂ over the course of T seconds while the air vehicle is in motion. The values I₁ and I₂ may be direct values when the environment is dark with only the LED for illumination, or may be the change in intensity change values between when the LED is off and when the LED is on. If the present course is preserved, the time until collision t may be estimated to be:

$$τ = T \frac{\sqrt{{I}_{1} / {I}_{2}}}{1 - \sqrt{{I}_{1} / {I}_{2}}} . \qquad ( Eq . 3 )$$

Color Sensing

Another variation of the active illumination versions of the above teachings is to use replace the LED (151 or 409) with multiple LEDs, each LED switched independently. Each LED may be selected to emit light at a different wavelength. A first image (or set of images) may be acquired when the first LED is lit, a second image (or set of images) may be acquired when the second LED is lit, and so on. This will allow color to be sensed in the environment. Additional images may be acquired when the LEDs are illuminated according to an illumination pattern where each LED is illuminated a predefined amount for one illumination pattern. The addition of color may then be used to identify new texture elements not visible by intensity alone. This can be used to increase the effectiveness and accuracy of any optical flow or other algorithms implemented. For example, suppose three different images were acquired using three different LEDs. This provides three times as much information to compute optical flow or detect objects or otherwise perceive the environment as when using just one LED. However “color opponency” images may then be computed by computing the differences between the three images, to provide three more sets of images, for a total of six sets of images. It will be understood that this technique may be applied in addition to the other teachings described above.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

I claim:

1. A vision system responsive to a visual environment comprising:
a plurality of photoreceptor circuits configured to generate a plurality of raw photoreceptor signals from the visual environment;
a plurality of pooling mechanisms configured to generate a plurality of pool signals based on the plurality of raw photoreceptor signals, wherein each pooling mechanism of the plurality of pooling mechanisms is selected from the group consisting of a spatial pooling mechanism, a temporal pooling mechanism, and a spatial-temporal pooling mechanism; and
an image processing mechanism configured to generate an output based on the plurality of pool signals.

2. The vision system of claim 1, further comprising a plurality of counting mechanisms configured to generate a plurality of count values, and wherein the plurality of pooling mechanisms is configured to generate the plurality of pool signals additionally based on the plurality of count values.

3. The vision system of claim 2, wherein each count value of the plurality of count values is binary, and each count value of the plurality of count values is associated with a unique photoreceptor circuit of the plurality of photoreceptor circuits.

4. The vision system of claim 3, wherein each counting mechanism of the plurality of counting mechanisms comprises a flip flop.

5. The vision system of claim 3, wherein each counting mechanism of the plurality of counting mechanisms comprises a capacitor.

6. The vision system of claim 1, wherein the plurality of pooling mechanisms comprise a plurality of temporal pooling mechanisms, and further comprising an adaptive mechanism configured to adjust the temporal pooling amount of the plurality of temporal pooling mechanisms based on the light levels of the visual environment.

7. The vision system of claim 6, wherein the adaptive mechanism is configured to adjust the temporal pooling amount so that for each pooling mechanism of the plurality of pooling mechanisms, the mu value of the pooling mechanism is substantially larger than the sigma value of the pooling mechanism.

8. The vision system of claim 7, wherein the plurality of photoreceptor circuits are able to respond to single photons.

9. The vision system of claim 1, wherein the plurality of pooling mechanisms comprise a plurality of spatial pooling mechanisms, and further comprising an adaptive mechanism capable of adjusting the spatial pooling amount of the plurality of spatial pooling mechanisms based on the light levels of the visual environment.

10. The vision system of claim 9, wherein the adaptive mechanism is configured to adjust the spatial pooling amount so that for each pooling mechanism of the plurality of pooling mechanisms, the mu value of the pooling mechanism is substantially larger than the sigma value of the pooling mechanism.

11. The vision system of claim 10, wherein the plurality of photoreceptor circuits are able to respond to single photons.

12. The vision system of claim 1, further comprising an angular rate sensor capable of generating an angular rate measurement of the vision system, and further comprising an adaptive mechanism capable of adjusting the spatial-temporal pooling amount of the plurality of pooling mechanisms based on the angular rate measurement.

13. The vision system of claim 1, further comprising an angular rate sensor capable of generating an angular rate signal based on the angular rate of the vision system, and wherein the receptive field of each pooling mechanism of the plurality of pooling mechanisms is configured to move based on the angular rate signal.

14. The vision system of claim 13, wherein the mu value of each pool signal is substantially larger than the sigma value of the pool signal.

15. The vision system of claim 1, further comprising an illuminator capable of illuminating the visual environment so that the mu value of at least one pool signal of the plurality of pool signals is substantially greater than the sigma value of the at least one pool signal.

16. The vision system of claim 15, wherein the illuminator is operated in an on-off pulsed manner, and the plurality of pool signals is generated based on the visual environment substantially only when the illuminator is on.

17. The vision system of claim 16, wherein the illuminator is adequately bright so that for at least one raw photoreceptor signal of the plurality of photoreceptor signals, the photocurrent portion of the raw photoreceptor signal is greater than the dark current portion of the raw photoreceptor signal.

18. The vision system of claim 16, wherein the vision system is attached to a mobile platform having an oscillating motion, and the pulse rate of the illuminator is synchronized with the oscillating motion.

19. The vision system of claim 18, wherein the plurality of pooling mechanisms are configured to generate the plurality of pool signals in response to light acquired over multiple cycles of the oscillating motion.

20. The vision system of claim 16, wherein the illuminator has a maximum continuous current rating and the current of the illuminator while the illuminator is on is greater than the maximum continuous current rating.

21. The vision system of claim 15, wherein:
the illuminator comprises a plurality of color illuminators;
each color illuminator is configured to emit light at a selected wavelength;
the plurality of color illuminators is capable of being powered in accordance with an illumination pattern selected from a set of illumination patterns; and
the plurality of pooling mechanisms generates a set of wavelength images, wherein each color image of the set of wavelength images is generated when the plurality of color illuminators is illuminated in accordance with one illumination pattern selected from the set of illumination patterns.

22. The vision system of claim 1, wherein:
the vision system is mounted on a mobile platform comprising a controller capable of controlling the motion of the mobile platform;
the controller comprises an inertial measurement unit configured to generate an angular rate signal based on the motion of the mobile platform, and is configured to control the angular rate of the mobile platform based on the angular rate signal; and
the controller is configured to control the position of the mobile platform based on the plurality of pool signals.

23. The vision system of claim 22, further comprising an optical flow computation means configured to generate an optical flow measurement based on the plurality of pool signals, and wherein the controller is configured to control the position of the mobile platform additionally based on the optical flow measurement.

24. The vision system of claim 22, wherein:
the controller is configured to substantially stabilize the pose of the mobile platform over a first time interval; and
the vision system is configured to generate the plurality of pool signals based on the history of the plurality of raw photoreceptor signals over a second time interval, wherein the second time interval occurs substantially within the first time interval.

25. The vision system of claim 22, wherein:
the controller is configured to substantially stabilize the pose of the mobile platform over a first time interval; and
the vision system is configured to generate the plurality of pool signals based on the history of the spatial sums of the plurality of pooling mechanisms over a second time interval, wherein the second time interval occurs substantially within the first time interval.

26. The vision system of claim 25, further comprising an optical flow computing means capable of generating an optical flow measurement based on the plurality of pool signals, and wherein the controller is additionally capable of controlling the position of the mobile platform based on the optical flow measurement.

27. The vision system of claim 25, wherein the first time interval and the second time interval are at least 100 milliseconds in duration.

28. The vision system of claim 22, further comprising an adaptive mechanism capable of adjusting the pooling parameters of the plurality of pooling mechanisms based on the light levels of the visual environment.

29. The vision system of claim 28, wherein the mu value of the plurality of pool signals is greater than the sigma value of the plurality of pool signals.

30. The vision system of claim 22, further comprising an adaptive mechanism capable of adjusting the pooling parameters of the plurality of pooling mechanisms based on the dynamics of the mobile platform.

31. The vision system of claim 22, wherein the pitch between adjacent pool signals is greater than two degrees.

32. The vision system of claim 22, wherein the pitch between adjacent pool signals is greater than five degrees.

33. The vision system of claim 22, wherein the pitch between adjacent photoreceptor circuits is greater than two degrees.

34. The vision system of claim 22, wherein the pitch between adjacent photoreceptor circuits is greater than five degrees.

35. The vision system of claim 22, wherein the receptive field of each pooling mechanism of the plurality of pooling mechanisms is configured to move based on the angular rate signal.

36. The vision system of claim 35, wherein the mobile platform is rotating.

37. The vision system of claim 35, wherein the receptive field of each pooling mechanism is configurable to point substantially in one direction over a time interval, and the plurality of pool signals are generated based on the history of the raw photoreceptor signals over the time interval.

38. The vision system of claim 35, wherein the receptive field of each pooling mechanism is configurable to point substantially in one direction over a time interval, and the plurality of pool signals are generated based on the histories of the spatial sums of the plurality of pooling mechanisms over the time interval.

39. The vision system of claim 22, wherein the field of view of the vision system spans at least 180 degrees.

40. The vision system of claim 39, wherein the field of view of the vision system substantially spans 360 degrees.

41. The vision system of claim 22, further comprising an illuminator configured to illuminate the visual environment.

42. The vision system of claim 41, further comprising a light dispersing structure having an exiting surface, wherein the illuminator sends light inside the light dispersing structure, and the light exits to the visual environment through the exiting surface.

43. The vision system of claim 41, further comprising a translucent shell and wherein light from the illuminator is dispersed through the translucent shell.

44. The vision system of claim 41, further comprising a capacitor and a switch, wherein a first end of the switch is connected to the capacitor, and a second end of the switch is connected to the illuminator, whereby the illuminator generates a light pulse when the switch is closed.

45. The vision system of claim 41, wherein the image processing mechanism is configured to detect other mobile platforms in the vicinity of the mobile platform.

46. The vision system of claim 22, wherein:
the plurality of pooling mechanisms comprises a first plurality of pooling mechanisms and a second plurality of pooling mechanisms;
the receptive fields of the first plurality of pooling mechanisms have a substantially rectangular shape oriented in a first orientation and generate a first set of pool signals;
the receptive fields of the second plurality of pooling mechanisms have a substantially rectangular shape oriented in a second orientation and generate a second set of pool signals;
the image processing mechanism computes a first set of visual motion measurements based on the first set of pool signals and a second set of visual motion measurements based on the second set of pool signals; and
the controller is configured to control the position of the mobile platform based on the first set of visual motion measurements and the second set of visual motion measurements.

47. The vision system of claim 1, wherein:
the plurality of photoreceptor circuits and the plurality of raw photoreceptor signals are arranged in a plurality of fields;
each field of the plurality of fields is associated with a unique optical structure;
each field of the plurality of fields is optically isolated from other fields of the plurality of fields;
each pool signal of the plurality of pool signals is associated with at least one raw photoreceptor signal of each field of the plurality of fields.

48. The vision system of claim 47, wherein the signal to noise ratio of each pool signal is greater than the signal to noise ratios of its associated raw photoreceptor signals.

49. The vision system of claim 47, wherein the receptive field of each field of the plurality of fields is substantially identical.

50. The vision system of claim 1, wherein the plurality of photoreceptor circuits comprises a plurality of photon detecting circuits capable of responding to individual photons.

51. The vision of claim 1, wherein the plurality of photoreceptor circuits comprises a plurality of active pixel circuits, and the plurality of pooling mechanisms comprise a plurality of temporal pooling mechanisms, and the light components of the plurality of pool signals are stronger than the Nyquist Johnson noise values of the plurality of pool signals.

52. The vision of claim 1, wherein the plurality of photoreceptor circuits comprises a plurality of active pixel circuits, and the plurality of pooling mechanisms comprise a plurality of spatial pooling mechanisms, and the light components of the plurality of pool signals are stronger than the Nyquist Johnson noise values of the plurality of pool signals.

53. The vision system of claim 1, further comprising a mode selection means, wherein:
the plurality of photoreceptor circuits comprises a plurality of active pixels circuits capable of operating in at least two modes selectable by a mode selecting signal;
the plurality of active pixel circuits responds linearly to light levels in the visual environment when the mode selecting signal selects the first mode of the at least two modes;
the plurality of active pixel circuits responds logarithmically to light levels in the visual environment when the mode selecting signal selects the second mode of the at least two modes; and
the mode selecting means generates the mode selecting signal.

54. The vision system of claim 53, wherein the mode selecting means generates the mode selecting signal based on the visual environment.

55. The vision system of claim 53, wherein:
each active pixel circuit comprises a first transistor connected to a reset signal and an integrating node and a second transistor connected to the integrating node;
each active pixel circuit operates in a logarithmic mode when the reset signal is set to a first value; and
each active pixel circuit operates in a linear mode when the reset signal is set to a second value.

56. The vision system of claim 53, wherein:
each active pixel circuit comprises a first transistor connected to a first reset signal and an integrating node, a second transistor connected to a second reset signal and the integrating node, and a third transistor connected to the integrating node;
each active pixel circuit operates in a logarithmic mode when the first reset signal and the second reset signal are set to a first configuration; and
each active pixel circuit operates in a linear mode when the first reset signal and the second reset signal are set to a second configuration.

57. The vision system of claim 53, wherein the integration interval of the plurality of photoreceptor circuits when the first mode is selected is computed based on the plurality of raw photoreceptor signals acquired when the second mode is selected.
